(19) United States
(12) Patent Application Publication
(10) Pub. No.: US 2010/0082875 A1
(43) Pub. Date: Apr. 1, 2010

(54) TRANSFER DEVICE

(75) Inventor: Mitsuru SATO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/556,785

(22) Filed: Sep. 10, 2009

(30) Foreign Application Priority Data
Sep. 26, 2008 (JP) 2008-248718

(51) Int. Cl. G06F 13/00

(52) U.S. Cl. 710/316

(57) ABSTRACT

A transfer device includes: a first input port operatively connected to a first apparatus; a second input port operatively connected to a second apparatus which is to run in parallel to the first apparatus; an output port operatively connected to a third apparatus; and a controller for controlling a data synchronization in accordance with a process including: receiving first and second data packets from the first and second apparatus, respectively, each of the first and second data packets including a check code; comparing one of the check codes in the first and second data packet with the other; and transferring at least the data of one of the first and second data packets upon determining coincidence of the check codes of the first and second data packets to the third apparatus via the output port.

### CROSS-REFERENCE TO RELATED APPLICATION

This application is based upon and claims the benefit of priority of the prior Japanese Patent Application No. 2008-248718, filed on Sep. 26, 2008, the entire contents of which are incorporated herein by reference.

### FIELD

A certain aspect of the embodiments discussed herein relates to a technique for a transfer device.

### BACKGROUND

Nowadays, computer systems have been widely used in various fields. The fields include such a field as requires high reliability. To realize high reliability in the computer systems used in these fields, developed is a multiplex system where all devices are multiplexed, and the multiplexed devices execute the same processing at the same time (hereinafter referred to as synchronous operation) to check processing results against one another.

As an example of such a multiplex system, disclosed is a technique of multiplexing plural CPUs (Central Processing Units) connected to one bridge and prompting the bridge to compare addresses and data included in information output from the CPUs to confirm whether the information match with one another.

Further, a multiplex system for multiplexing devices at an input/output level has been developed. A specific example thereof will be described with reference to FIG. 9. As shown in FIG. 9, a computer system 1 and a computer system 2 constituting a multiplex system are each configured by a CPU, a memory, an I/O bridge as an input/output device, I/O adaptors, and a magnetic disk device, and each device is duplicated. In addition, in the computer system 1 and the computer system 2, the I/O bridge and the plural I/O adaptors are connected via a bus. Then, it is determined by comparison whether traffic between the I/O bridge and the I/O adaptors in the computer system 1 match traffic between the I/O bridge and the I/O adaptors in the computer system 2 to confirm whether the traffics match with each other.

Here, the computer system employs PCI Express that is standardized by PCI-SIG (PCI Special Internet Group) for connection with the input/output device in order to achieve a high-speed response. FIG. 10 shows an example of a computer system employing PCI Express. As shown in FIG. 10, in the computer system employing PCI Express, an I/O bridge is connected with plural I/O adaptors by way of a PCI Express switch. As a result, the I/O bridge connected with the plural I/O adaptors by way of a PCI Express switch ensures one communication line to each I/O adaptor to thereby realize high-speed communications in the computer system.

There is a multiplex system where a CPU is multiplexed in a computer system employing the above PCI Express switch. A specific example thereof will be described with reference to FIG. 11. As shown in FIG. 11, in the multiplex system using the PCI Express switch, a CPU, a memory, an I/O bridge as an input/output device, I/O adaptors, and a magnetic disk device are duplicated, and the input/output devices are connected by way of the PCI Express switch. Therefore, it is also possible to confirm whether traffic between the I/O bridge and I/O adaptors subordinate to one CPU matches traffic between the I/O bridge and I/O adaptors subordinate to the other CPU by the PCI Express switch comparing the traffics with each other.

Japanese Laid-open Patent Publication No. 2002-518735 discloses multi-processor computer system including first and second processing sets which communicate with an I/O device bus.

### SUMMARY

According to an aspect of an embodiment, a transfer device includes: a first input port operatively connected to a first apparatus; a second input port operatively connected to a second apparatus which is to run in parallel to the first apparatus; an output port operatively connected to a third apparatus; and a controller for controlling a data synchronization in accordance with a process including: receiving first and second data packets in parallel from the first and second apparatus via the first and second inputs port, respectively, each of the first and second data packets including a check code generated by check code operation over data contained in each of the first and second data packets; comparing one of the check codes in the first and second data packet with the other; and transferring at least the data of one of the first and second data packets upon determining coincidence of the check codes of the first and second data packets to the third apparatus via the output port.

The object and advantages of the invention will be realized and attained by means of the elements and combinations particularly pointed out in the claims.

It is to be understood that both the forgoing general description and the following detailed description are exemplary and explanatory and are not respective of the invention, as claimed.

### BRIEF DESCRIPTION OF DRAWINGS

FIG. 1 shows an example of the overall configuration of a synchronous operation system according to a first embodiment.

FIG. 2 is a functional block diagram showing the configuration of a PCI Express switch according to the first embodiment.

FIG. 3 shows a synchronous operation that is performed using a pseudo port.

FIG. 4 shows a PCI Express packet format.

FIG. 5 is a flowchart of a synchronous operation according to the first embodiment.

FIG. 6 shows an example of the overall configuration of a synchronous operation system according to a second embodiment.

FIG. 7 is a functional block diagram showing the configuration of a PCI Express switch according to the second embodiment.

FIG. 8 is a flowchart of a synchronous operation according to the second embodiment.

FIG. 9 shows a conventional multiplex system at an input/output level.

FIG. 10 shows a conventional system using PCI Express.

FIG. 11 shows a conventional system where plural CPUs are connected to a PCI Express switch.

### DESCRIPTION OF EMBODIMENTS

Hereinafter, embodiments of a transfer device, a transfer method, and a transfer program according to the present invention will be illustrated with reference to the drawings. Here, the transfer device according to the embodiments of the present invention is a PCI Express switch with a PCI Express interface, but the present invention should not be limited by the embodiments.

### First Embodiment

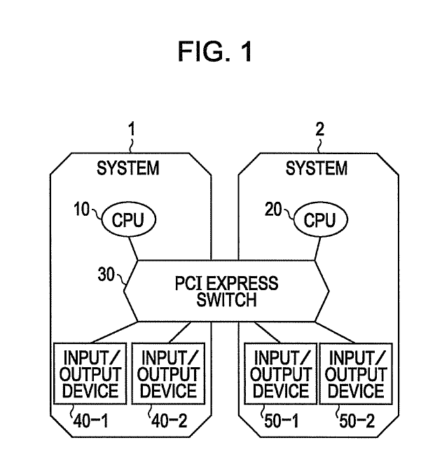

FIG. 1 shows an example of the overall configuration of a synchronous operation system including a PCI Express switch according to a first embodiment. As shown in FIG. 1, the synchronous operation system is a redundant system constituted of a system 1 and a system 2. The system 1 includes a CPU 10, and input/output devices 40-1 and 40-2, and the system 2 includes a CPU 20, and input/output devices 50-1 and 50-2. A PCI Express switch 30 connects the system 1 and the system 2. Here, it is assumed that the synchronous operation system adopts a dual system, and the system 1 and the system 2 operate in sync with each other. In other words, the CPUs 10 and 20, the input/output devices 40-1 and 50-1, and the input/output devices 40-2 and 50-2 are each duplicated, and these devices perform synchronous operation to execute the same processing at the same time. Although the system 1 and the system 2 have completely identical system configuration in the illustrated example of FIG. 1, the configuration is not limited thereto. The same system configuration is not always necessary as in the case where either one system dispenses with a CPU or some input/output devices, for example. Further, the following description is focused on devices in the system 1. Devices in the system 2 are similar to those in the system 1 and thus not described herein.

The CPU 10 is a central processing unit for executing processing of a program with an input/output instruction. For example, the CPU 10 outputs packet data for requesting input/output processing, which is addressed to the input/output device 40-1, toward the PCI Express switch 30 in order to request the input/output device 40-1 to perform input/output processing. At this time, in the case where the system 2 is provided with the CPU 20, the CPU 20 operates in sync with the CPU 10 and thus, the CPU 20 executes the same program as in the CPU 10 at the same time to output packet data addressed to the synchronized input/output device 50-1, toward the PCI Express switch 30. In addition, the CPU 10 obtains packet data representing a processing result of the input/output device 40-1 from the PCI Express switch 30. At this time, in the case where the system 2 is provided with the CPU 20, the CPU 20 obtains packet data representing a processing result of the synchronized input/output device 50-1 from the PCI Express switch 30. Although not shown, the CPUs 10 and 20 are connected with the memory and the I/O bridge.

After having received the packet data output from the CPU 10 to the input/output device 40-1 and the packet data output from the CPU 20 to the input/output device 50-1, the PCI Express switch 30 compares LCRCs (Link Cyclic Redundancy Check) added to the received packet data. Here, in the case where the CPU 20 is not provided, the PCI Express switch 30 does not compare LCRCs because packet data is output only from the CPU 10.

Here, the LCRC refers to an error detection/correction code for a data link layer of an OSI reference model standardized by the PCI Express interface. The PCI Express interface performs high-speed data communications. Thus, if packet data is transmitted/received between devices through the PCI Express switch, it is necessary to check whether an error occurs during transfer of the packet data. For that purpose, the LCRC is added to packet data to check whether an error occurs during transfer of the packet data.

If the LCRC received from the CPU 10 matches with the LCRC received from the CPU 20 as a result of comparing the LCRC received from the CPU 10 with the LCRC received from the CPU 20, the PCI Express switch 30 selects one packet data. In the case where the CPU 20 is not provided, the LCRC is received only from the CPU 10. Thus, the packet data output from the CPU 10 is selected. Then, the PCI Express switch 30 duplicates the packet data as many times as the number of times the input/output device 40-1 as a destination of the selected packet data is multiplexed. The number of multiplexed devices is 2 in the illustrated example of FIG. 1 because the system 1 and the system 2 are duplicated. After that, in order to determine ports connected to a device as a destination of packet data and multiplexed devices, the PCI Express switch 30 reads ports corresponding to ports derived from the destination of duplicated packet data, from information about predetermined ports connected to each of the multiplexed devices. Then, the PCI Express switch 30 outputs the duplicated packet data to the read ports. Further, in the above description, the PCI Express switch 30 receives the packet data output from the CPU 10. However, since the same processing is performed if the switch receives packet data output from the input/output devices 40-1 and 40-2, a description thereof is omitted.

When receiving packet data output from the PCI Express switch 30, the input/output devices 40-1 and 40-2 perform processing in accordance with the content of the packet data. For example, if receiving a read request, the input/output devices 40-1 and 40-2 read data from the input/output device. If receiving a write request, the input/output devices 40-1 and 40-2 write data included in the packet data to the input/output device. Then, the input/output devices 40-1 and 40-2 output packet data representing a processing result to the PCI Express switch 30. Further, the input/output devices 40-1 and 40-2 are, for example, a magnetic disk device and a network device, but any devices connectable to the PCI Express interface may be used; any I/O adaptor that enables conversion to the PCI Express interface may be used instead.

In general, the LCRC is used to protect packet data transferred on a PCI Express link (line between the PCI Express switch 30 and the input/output device 40-1, for example), and generated by devices at both ends of the PCI Express link. In other words, the LCRC is generated by a sender of packet data, for example, the PCI Express switch 30 based on the generating polynomial of the packet data and a predetermined LCRC. The PCI Express switch 30 adds the generated LCRC to the packet data and outputs the data to a destination of the data, for example, the input/output device 40-1. Then, the input/output device 40-1 having received the packet data added with the LCRC generates an LCRC based on the received packet data and the same generating polynomial as in the sender to compare the LCRC added to the received packet data with the generated LCRC. If the LCRC added to the received packet data matches the generated LCRC as a result of comparison, it is confirmed that no error is involved in the packet data transferred between the input/output device 40-1 and the PCI Express switch 30. On the other hand, if the LCRC added to the received packet data does not match the generated LCRC, it is confirmed that the packet data involves an error.

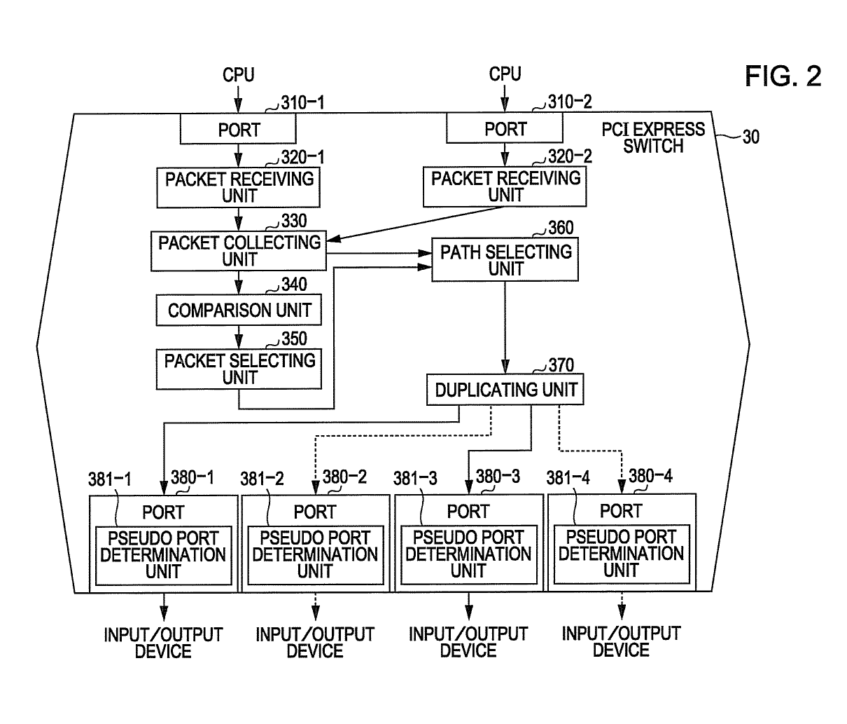

FIG. 2 is a functional block diagram showing the configuration of the PCI Express switch according to the first embodiment. As shown in FIG. 2, the PCI Express switch 30 includes ports 310-1 and 310-2, packet receiving units 320-1 and 320-2, a packet collecting unit 330, a comparison unit 340, a packet selecting unit 350, a path selecting unit 360, a duplicating unit 370, and ports 380-1 to 380-4. In the illustrated example of FIG. 2, the PCI Express switch 30 outputs packet data received from the CPU to the input/output device but may output packet data received from the input/output device to the CPU. In addition, the packet receiving units 320-1 and 310-2 correspond to “first receiving means” and “second receiving means” described in the scope of claims, respectively, and the packet collecting unit 330 includes “determination means” described in the scope of claims.

The ports 310-1 and 310-2 are ports communicating with the PCI Express switch 30 and the CPUs 10 and 20, respectively.

The packet receiving unit 320-1 waits until the CPU 10 sends packet data through the port 310-1. If receiving the packet data, the unit outputs the received packet data to the packet collecting unit 330.

The packet receiving unit 320-2 waits the CPU 20 to send packet data through the port 310-2. If receiving the packet data, the unit outputs the received packet data to the packet collecting unit 330. Here, since the CPUs 10 and 20 operate in sync with each other, the packet receiving units 320-1 and 320-2 receive packet data representing a processing result obtained through the synchronous operation.

The packet collecting unit 330 references information about whether the CPUs 10 and 20 are multiplexed. If the CPUs 10 and 20 are multiplexed, the packet receiving units 320-1 and 320-2 collect packet data. Then, after having collected packet data output from the packet receiving units 320-1 and 320-2, the packet collecting unit 330 outputs the respective packet data to the comparison unit 340. On the other hand, if confirming that the CPUs 10 and 20 are not multiplexed with reference to information about whether the CPUs 10 and 20 are multiplexed, the packet collecting unit 330 receives packet data output from either one of the packet receiving units 320-1 and 320-2 and then outputs the packet data to the path selecting unit 360. Further, the information about whether the CPUs 10 and 20 are multiplexed is saved in the packet collecting unit 330 in advance.

After having received the respective packet data output from the packet collecting unit 330, the comparison unit 340 extracts LCRCs added to the respective packet data and compares the extracted LCRCs with one another. If the extracted LCRCs are matched as a result of comparison, the comparison unit 340 outputs the packet data including the matched LCRCs to the packet selecting unit 350. On the other hand, if the extracted LCRCs are not matched as a result of comparison, the comparison unit 340 outputs data to the effect that an error occurs during a synchronous operation. Here, a format of the packet data added with the LCRC is described in detail below.

The packet selecting unit 350 selects one of plural packet data output from the comparison unit 340. The packet selecting unit 350 selects one of the respective packet data and deletes the remaining packet data. Then, the packet selecting unit 350 outputs the selected packet data to the path selecting unit 360.

In order to output the packet data to an input/output device corresponding to a destination included in the packet data output from the packet selecting unit 350, the path selecting unit 360 selects a path based on the destination. For example, the path selecting unit 360 selects an identification number of a port where packet data is output, based on the destination included in the packet data output from the packet selecting unit 350. Then, the path selecting unit 360 outputs the packet data and the selected identification number of the port to the duplicating unit 370.

If receiving the packet data and the identification number of the port output from the path selecting unit 360, the duplicating unit 370 duplicates the packet data as many times as the number of times the input/output device as a destination of the packet data is multiplexed. For example, the duplicating unit 370 reads a pair corresponding to the identification number of the port from a port number correspondence table saved in the duplicating unit 370 in advance. Here, the port number correspondence table refers to a table showing identification numbers of ports connected to each pair of multiplexed input/output devices. Then, the duplicating unit 370 duplicates packet data as many times as the number of identification numbers of ports included in the read pair. Further, the duplicating unit 370 outputs the duplicated packet data to the ports 380-1 to 380-4 corresponding to the port identification numbers included in the read pair.

The ports 380-1 to 380-4 are ports communicating with the PCI Express switch 30 and the input/output devices (40-1, 40-2, 50-1, and 50-2) connected thereto, and provided with pseudo port determination units 381-1 to 381-4, respectively.

The pseudo port determination units 381-1 to 381-4, respectively receives the packet data output from the duplicating unit 370 and determines whether the ports 380-1 to 380-4 in the respective units are pseudo ports. Here, the pseudo port refers to a port not connected to a device to be multiplexed. If it is determined that the port in each unit is not a pseudo port, the pseudo port determination units 381-1 to 381-4 output packet data to the input/output device connected to the port. On the other hand, if it is determined that the port in each unit is a pseudo port, pseudo port determination units 381-1 to 381-4 delete packet data. Further, information about whether the port in each unit is a pseudo port is saved in the pseudo port determination units 381-1 to 381-4 in advance.

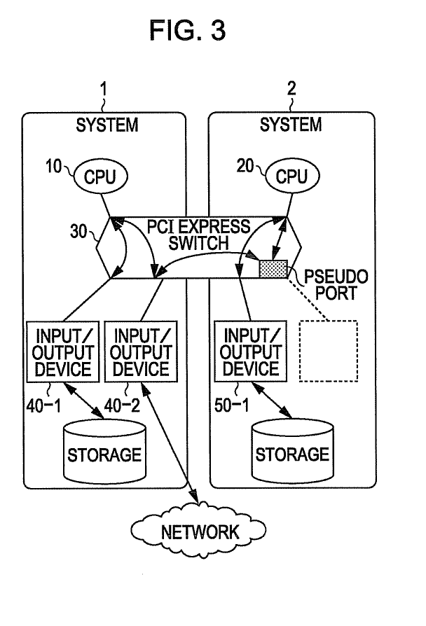

Referring to FIG. 3, a description is given of an example of a synchronous operation with a pseudo port. As shown in FIG. 3, the systems 1 and 2 are redundant systems. The CPUs 10 and 20 and the input/output devices 40-1 and 50-1 are configured by multiplexing paired devices to operate in sync with each other. However, an input/output device to be multiplexed with the input/output device 40-2 in the system 1 is neither provided in the system 2 nor connected to the PCI Express switch 30. Thus, a port of the input/output device to be multiplexed is a pseudo port. Here, the input/output device 40-2 is assumed a network device connected to a network in the illustrated example of FIG. 3.

The PCI Express switch 30 compares LCRCs added to packet data received from the CPUs 10 and 20 with each other. If the LCRCs are matched as a result of comparison, the packet data is duplicated. Then, the PCI Express switch 30 outputs the duplicated packet data to a port connected to the input/output device 40-2 as well as to a pseudo port of an input/output device to be multiplexed with the input/output device 40-2. Moreover, the pseudo port deletes the output packet data. As a result, the PCI Express switch 30 sends only one packet data out of packet data representing the multiplexed processing results to a network through the input/output device 40-2. Thus, a multiplex system using a network device can be easily realized.

Further, the PCI Express switch 30 receives packet data from a network through the input/output device 40-2, and duplicates packet data for two devices because the CPUs 10 and 20 are multiplexed and then, outputs the duplicated packet data to the CPUs 10 and 20. Hence, the external network outside of the multiplex system does not need to install a function of distributing packet data to multiplexed network devices. Therefore, the PCI Express switch 30 can reduce an additional cost for establishing the multiplex system including the network devices.

By using the pseudo ports as described above, the PCI Express switch 30 enables a synchronous operation even if the systems 1 and 2 do not have completely identical configuration.

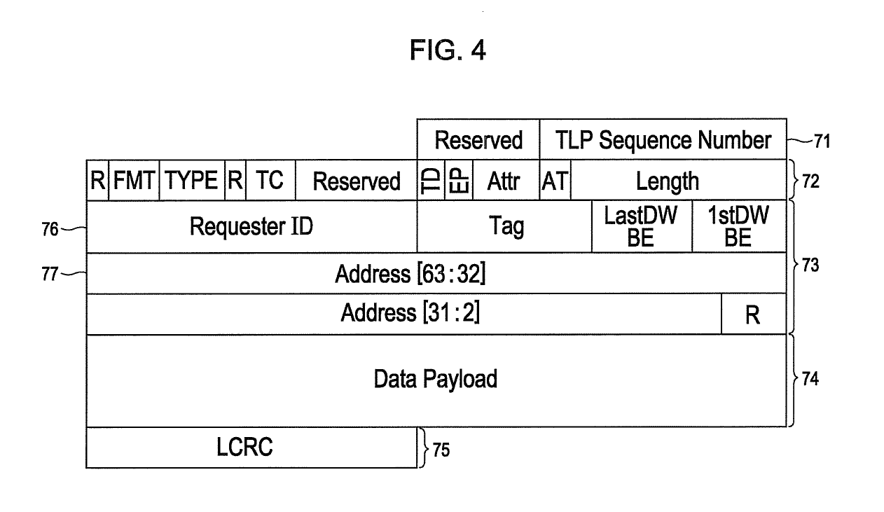

Referring to FIG. 4, a format of packet data added with an LCRC is described next. FIG. 4 shows a format as an example of packet data used in the PCI Express interface. As shown in FIG. 4, the PCI Express packet format includes a sequence number 71 of packet data, a common header 72 including a type of packet data, a header 73 having such a format as varies depending on the type of packet data, and a data payload 74 for setting target data for transmission, and an LCRC 75 is added at the end thereof.

The header 73 includes a request number 76 indicating which device sends a request, and an address 77 indicating a device as a destination of the request. For example, if the CPU 10 requests the input/output device 40-1 to execute input/output processing, the CPU 10 sets an identification number of the CPU 10 as a sender to the request number 76 of packet data and sets an address of the input/output device 40-1 to the address 77.

The LCRC 75 is generated from the packet data. The PCI Express switch 30 compares whether packet data output from each of synchronous devices match with one another based on the LCRC 75. Therefore, the packet data output from each of synchronous devices need to match with one another in terms of data other than the data set to the data payload 74. For that purpose, the synchronous devices to be multiplexed are set to have the same bus number and device number. Further, the synchronous devices start operating after resetting the sequence number 71, at the start of synchronous operation. Thus, the respective packet data match each other in terms of the sequence number 71, the request number 76, and the address 77. If the synchronous operation is normally performed, the LCRCs 75 are matched together.

If the LCRCs 75 of the packet data representing results of the synchronous operation are matched as above, the PCI Express switch 30 can compare the packet data by comparing the LCRCs 75 generated from the packet data, not by directly comparing the packet data. Hence, it is possible to relatively reduce a comparison time as well as comparison processing amount. As a result, the PCI Express switch 30 can compare packet data at high speeds. Further, the LCRC 75 is the specification of the PCI Expression interface. Thus, the LCRC 75 is added to every packet data transmitted through the PCI Express interface. Therefore, it is unnecessary to develop a new LCRC 75 for comparison, and it is only necessary to develop a comparison circuit for comparing added LCRCs 75. Hence, the PCI Express switch 30 can compare packet data at low costs.

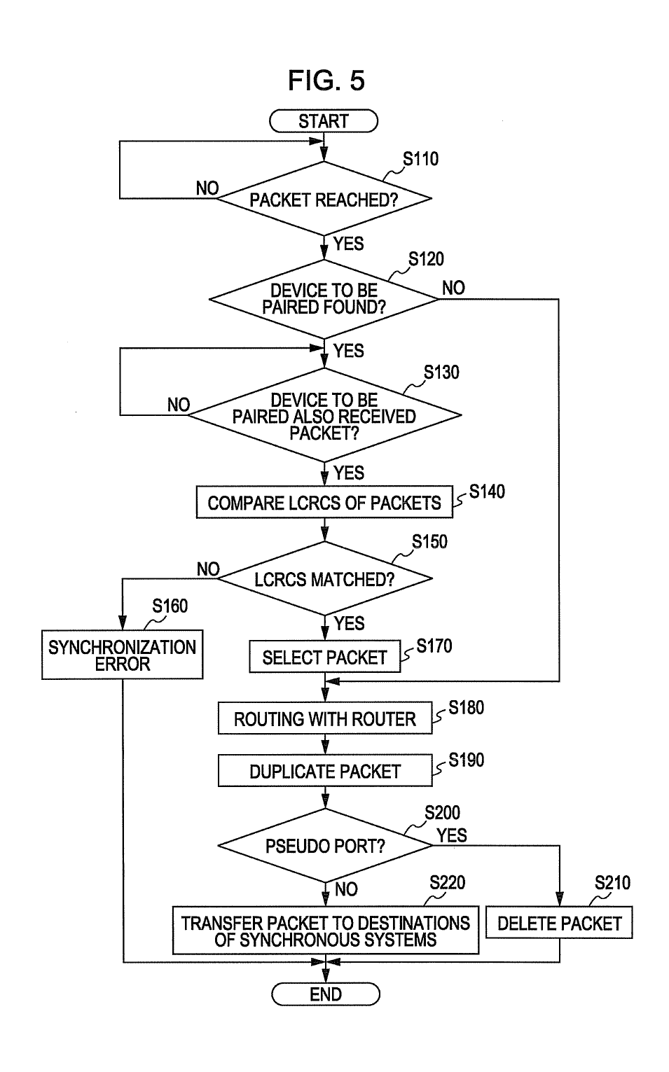

Referring to FIG. 5, the synchronous operation of the first embodiment is described next. FIG. 5 is a flowchart of the synchronous operation of the first embodiment. The following description is made on the assumption that packet data representing a request for input/output processing is output from the CPU 10 to the input/output device 40-1, and that the system 1 provided with the CPU 10 and the input/output device 40-1 and the system 2 provided with the CPU 20 and the input/output device 50-1 are multiplex systems.

First, the packet receiving unit 320-1 determines whether packet data output from the CPU 10 has reached (S110). If the packet data output from the CPU 10 has not reached (S110; No), the packet receiving unit 320-1 waits for arrival of the packet data output from the CPU 10. On the other hand, if the packet data output from the CPU 10 has reached (S110; Yes), the packet receiving unit 320-1 outputs the packet data to the packet collecting unit 330.

Similar to the packet receiving unit 320-1, the packet receiving unit 320-2 determines whether packet data output from the CPU 20 operating in sync with the CPU 10 has reached (S110). If the packet data output from the CPU 20 has not reached (S110; No), the packet receiving unit 320-2 waits for arrival of the packet data output from the CPU 20. On the other hand, if the packet data output from the CPU 20 has reached (S110; Yes), the packet receiving unit 320-2 outputs the packet data to the packet collecting unit 330.

Subsequently, after having received the packet data from the packet receiving unit 320-1, for example, the packet collecting unit 330 determines whether any CPU is multiplexed with the CPU 10 that output the packet data received with the packet receiving unit 320-1 (S120). If no CPU is multiplexed with the CPU 10 (S120; No), the packet collecting unit 330 outputs the packet data to the path selecting unit 360.

On the other hand, if any CPU is multiplexed with the CPU 10 (S120; Yes), the packet collecting unit 330 determines whether packet data output from the synchronized CPU 20 has reached (S130). If the packet data output from the synchronized CPU 20 has not reached (S130; No), the packet collecting unit 330 waits for arrival of packet data output from the synchronized CPU. On the other hand, if the packet data output from the synchronized CPU has reached (S130; Yes), the packet collecting unit 330 outputs plural packet data sent from the two synchronized CPUs to the packet comparison unit 340.

After receiving the two packet data, the packet comparison unit 340 compares LCRCs added to the packet data (S140).

Then, the packet comparison unit 340 determines whether the LCRCs added to the packet data match each other (S150). If the LCRCs do not match each other (S150; No), the packet comparison unit 340 outputs a message that an error occurs during the synchronous operation (S160) and terminates the synchronous operation.

On the other hand, if the LCRCs match each other (S150; Yes), the packet comparison unit 340 outputs the two packet data to the packet selecting unit 350.

Then, the packet selecting unit 350 selects one of the two packet data (S170), and deletes the other packet data. After that, the packet selecting unit 350 outputs the selected packet data to the path selecting unit 360.

After receiving the packet data from the packet collecting unit 330 or the packet selecting unit 350, the path selecting unit 360 selects an identification number of a port for outputting the packet data, based on a destination included in the packet data, for example (S180). Then, the path selecting unit 360 outputs the packet data and the selected port identification number to the 370.

After receiving the packet data and the port identification number, the 370 duplicates the packet data as many times as the number of multiplexed input/output devices as a destination of the packet data (S190). For example, the 370 reads a pair corresponding to the port identification number from the port number correspondence table and including a port identification number of each of multiplexed input/output devices. Then, the 370 duplicates the packet data as many times as the number of ports included in the read pair. Further, the 370 outputs the duplicated packet data to the pseudo port determination units 381-1 to 381-4 corresponding to the port identification numbers included in the read pair.

After receiving the packet data output from the 370, the pseudo port determination units 381-1 to 381-4 determine whether the port in each unit is a pseudo port (S200). If the port in each unit is a pseudo port (S200; Yes), the pseudo port determination units 381-1 to 381-4 delete the packet data (S210). On the other hand, if the port in each unit is not a pseudo port (S200; No), the pseudo port determination units 381-1 to 381-4 send packet data to each input/output device connected to the ports, for example, the input/output device 40-1 and the input/output device 50-1 (S220).

According to the first embodiment, the PCI Express switch 30 obtains an LCRC used for detecting an error in packet data representing a result of processing in the CPU 10 connected to its own device as above. If the PCI Express switch 30 receives the LCRC of the packet data representing a result of processing in the CPU 10, it is determined whether any device is multiplexed with the CPU 10 and operated in sync with the CPU 10 to execute the same processing at the same time. If any synchronized device is found, the PCI Express switch 30 obtains an LCRC of packet data representing a result of the synchronous operation of the CPU 20 operating in sync therewith. Then, the PCI Express switch 30 compares the obtained LCRCs of the packet data output from the CPUs 10 and 20.

In this way, if devices operate in sync with each other, the PCI Express switch 30 compares packet data using error detection information about each packet data representing a result of synchronous operation. Thus, a data amount smaller than the original packet data suffices for comparison, and a comparison time can be reduced. In addition, the PCI Express switch 30 can simplify a test circuit and in addition, can save a storage area used for comparison processing because an amount of data to be compared is smaller than the original packet data. As a result, the PCI Express switch 30 can efficiently secure reliability of synchronous devices. Further, if no device operates in sync with a target device, packet data representing a result of synchronous operation is not generated. Thus, even if systems to be multiplexed for synchronous operation do not have completely identical device configuration, the PCI Express switch 30 can continuously execute synchronous operation thereafter and thus secure device reliability with higher reliability. As a result, it is possible to reduce a cost for configuring a multiplex system.

### Second Embodiment

The above first embodiment describes an example where the synchronous operation system using the PCI Express switch 30 is a multiplex system constituted of two systems. However, the present invention is not limited to the above example but is applicable to a multiplex system constituted of three or more systems.

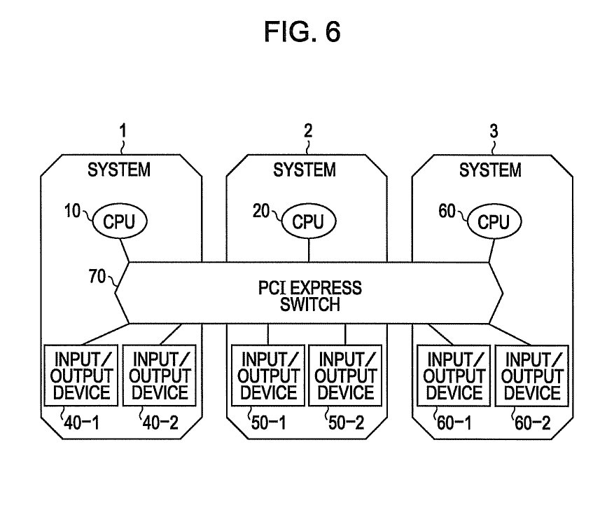

To that end, in a second embodiment, a multiplex system constituted of three systems is a described as a synchronous operation system using the PCI Express switch 30. Referring to FIG. 6, the overall configuration of the synchronous operation system according to the second embodiment is described first. FIG. 6 shows an example of the overall configuration of the synchronous operation system according to the second embodiment. As shown in FIG. 6, in the synchronous operation system according to the second embodiment, a system 3 is added to the synchronous operation system of the first embodiment (FIG. 1). In FIG. 6, the same components as those in FIG. 1 are denoted by identical reference numerals and not described in detail.

The system 3 is provided with a CPU 60, and input/output devices 60-1 and 60-2. A PCI Express switch 70 connects the system 1, the system 2, and the system 3 with one another. In addition, in the synchronous operation system, the CPUs 10, 20, and 60, the input/output devices 40-1, 50-1, and 60-1, and the input/output devices 40-2, 50-2, and 60-2 are each triplicated to operate in sync with one another to perform the same processing at the same time. In the illustrated example of FIG. 6, the system 1, the system 2, and the system 3 have completely identical system configuration, but the configuration is not limited thereto. For example, the same system configuration is not always necessary as in the case where any system dispenses with a CPU or some input/output devices. Further, since functions of the CPU 60, and the input/output devices 60-1 and 60-2 are similar to those of the CPU 10, and the input/output devices 40-1 and 40-2, a description thereof is omitted here.

After having received packet data output from the CPU 10 to the input/output device 40-1, packet data output from the CPU 20 to the input/output device 50-1, and packet data output from the CPU 60 to the 60-1, the PCI Express switch 70 compares LCRCs added to the received packet data. Here, in the case where the CPU 20 or the CPU 60 is not provided, the PCI Express switch 70 does not compare LCRCs because packet data is output only from the CPU 10.

If the LCRCs received from the CPUs 10, 20, and 60 match with one another as a result of comparison based on the LCRCs, the PCI Express switch 70 selects one packet data. On the other hand, if the LCRCs received from the CPUs 10, 20, and 60 do not match with one another as a result of comparison based on the LCRCs, the PCI Express switch 70 compares the numbers of matched LCRCs to determine the most matched LCRCs by majority to thereby select packet data corresponding to the determined LCRCs. Here, in the case where the CPU 20 or 60 is not provided, the LCRC is received only from the CPU 10. Thus, the packet data output from the CPU 10 is selected. Then, the PCI Express switch 70 duplicates the packet data as many times as the number of times the input/output device 40-1 as a destination of the selected packet data is multiplexed. The number of multiplexed devices is 3 in the illustrated example of FIG. 6 because of the triplicated systems. After that, in order to determine ports connected to a device as a destination of packet data and multiplexed devices, the PCI Express switch 70 reads ports corresponding to ports derived from the destination of duplicated packet data, from information about predetermined ports connected to each of the multiplexed devices. Then, the PCI Express switch 70 outputs the duplicated packet data to the read ports. Further, in the above description, the PCI Express switch 70 receives the packet data output from the CPU 10. However, since the same processing is performed if the switch receives packet data output from the input/output devices 40-1 and 40-2, a description thereof is omitted.

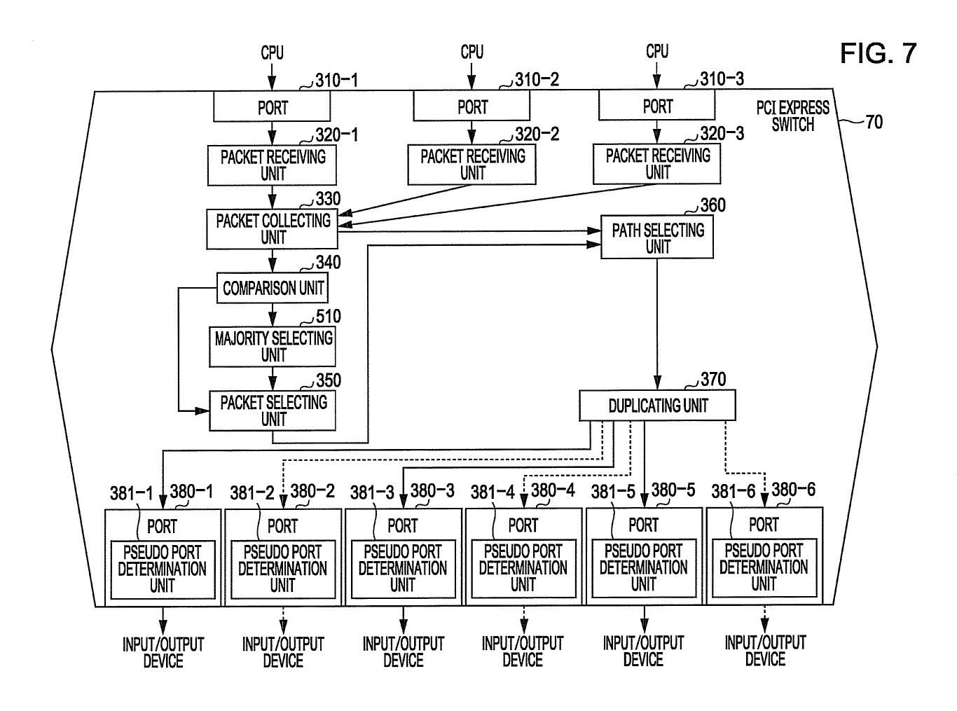

Referring to FIG. 7, the configuration of the PCI Express switch according to the second embodiment will be described next. FIG. 7 is a functional block diagram showing the configuration of the PCI Express switch according to the second embodiment. As shown in FIG. 7, in the PCI Express switch 70 according to the second embodiment, a port 310-3, a packet receiving unit 320-3, and ports 380-5 and 380-6 are added to the PCI Express switch 30 of the first embodiment, and the switch is modified in terms of a majority decision unit 510. In FIG. 7, the same components as those of FIG. 2 are denoted by identical reference numerals and not described in detail. Further, in the illustrated example of FIG. 7, the PCI Express switch 70 outputs packet data received from the CPU to the input/output device but may output packet data received from the input/output device to the CPU.

The port 310-3 is a port communicating with the CPU 60 and the PCI Express switch 70.

The packet receiving unit 320-3 waits until the CPU 60 sends packet data through the port 310-3. If receiving the packet data, the unit outputs the received packet data to the packet collecting unit 330.

The packet collecting unit 330 references information about whether the CPU 10, 20, or 60 is multiplexed. If any CPU is multiplexed, the packet receiving units 320-1 to 320-3 corresponding to the multiplexed CPU collect packet data. Then, after having collected packet data output from the packet receiving units 320-1 to 320-3 corresponding to the multiplexed CPU, the packet collecting unit 330 outputs the respective packet data to the comparison unit 340. If the CPU 10, 20, or 60 is not multiplexed, the packet collecting unit 330 receives packet data output from any one of the packet receiving units 320-1 to 320-3 and outputs the packet data to the path selecting unit 360.

After having received the respective packet data output from the packet collecting unit 330, the comparison unit 340 extracts LCRCs added to the respective packet data and compares the extracted LCRCs with one another. If all the extracted LCRCs are matched as a result of comparison, the comparison unit 340 outputs the packet data including the matched LCRCs to the packet selecting unit 350. On the other hand, if some of the extracted LCRCs are matched as a result of comparison, the comparison unit 340 outputs packet information including a set of packet data corresponding to the matched LCRCs and the number of matched LCRCs to the majority decision unit 510. Further, if none of the extracted LCRCs are matched as a result of comparison, the packet comparison unit 340 outputs data to the effect that an error occurs in a synchronous operation.

The majority decision unit 510 receives the packet information output from the packet comparison unit 340 and compares the numbers of matched LCRCs to determine the most matched LCRCs by majority. In other words, the majority decision unit 510 determines a set of LCRCs as the most matched LCRCs among the sets included in the packet information and then outputs plural packet data corresponding to the determined set to the packet selecting unit 350.

The packet selecting unit 350 selects one of the plural packet data output from the comparison unit 340 or the majority decision unit 510. The packet selecting unit 350 selects one of the respective packet data and deletes the remaining packet data. Then, the packet selecting unit 350 outputs the selected packet data to the path selecting unit 360.

The ports 380-5 and 380-6 are ports communicating with the PCI Express switch 70 and the input/output devices (60-1 and 60-2) connected thereto, and provided with pseudo port determination units 381-5 and 381-6, respectively. Further, functions of the pseudo port determination units 381-5 and 381-6 are similar to those of the pseudo port determination units 381-1 and 381-2 and thus not described here.

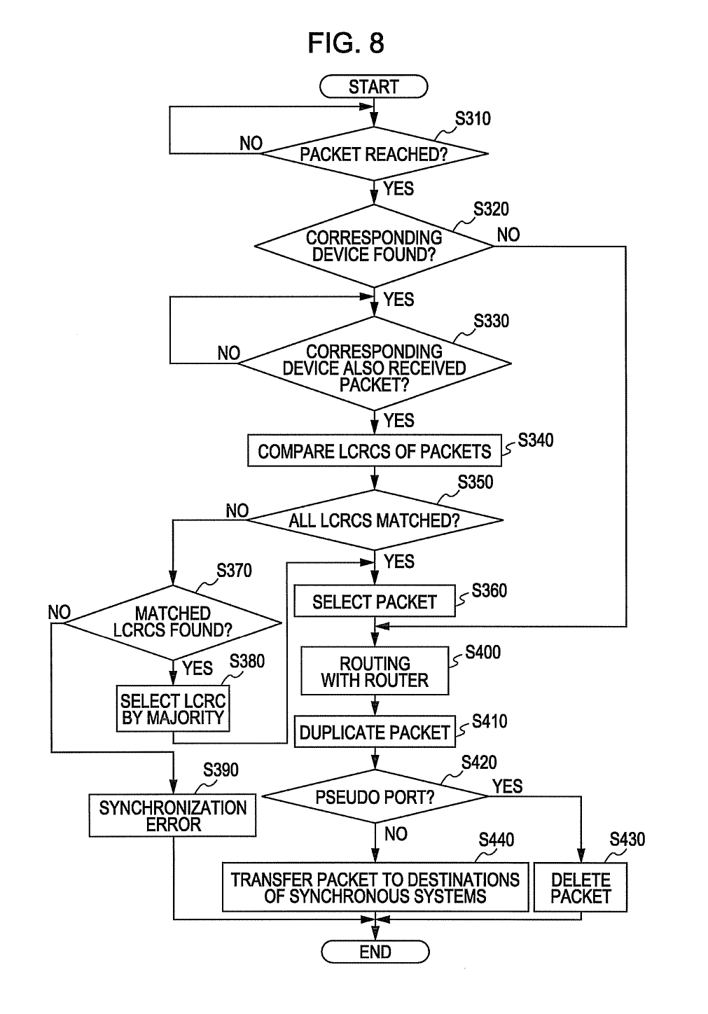

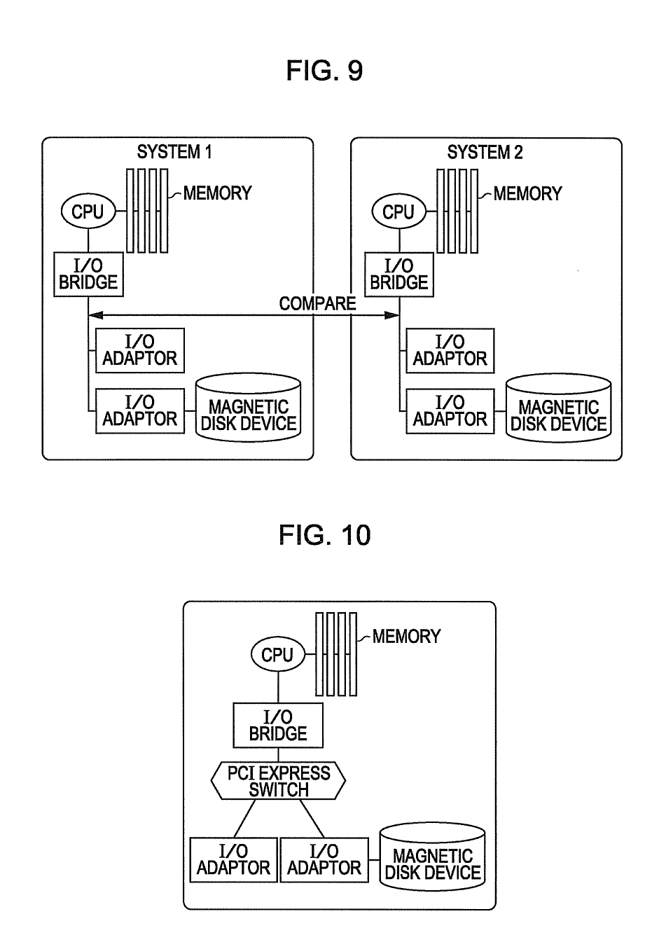

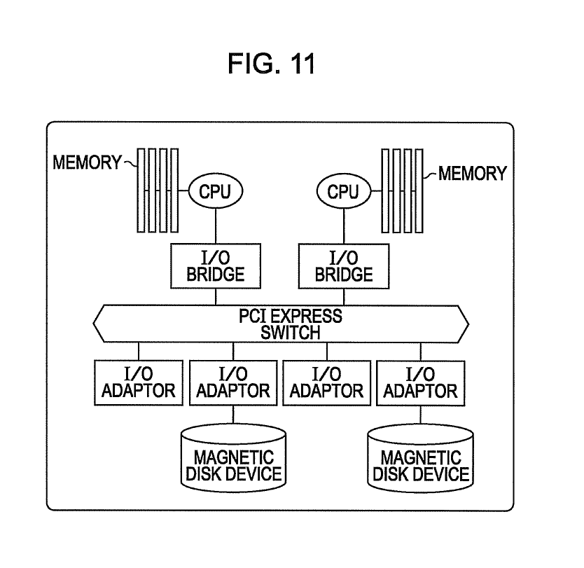

Referring to FIG. 8, the synchronous operation of the second embodiment will be described next. FIG. 8 is a flowchart of the synchronous operation of the second embodiment. In the following description, it is assumed that the CPU 10 outputs packet data requesting input/output processing toward the input/output device 40-1, and the system 2 provided with the CPU 20 and the input/output device 50-1 and the system 3 provided with the CPU 60 and the input/output device 60-1 are multiplexed.

First, the packet receiving unit 320-1 determines whether packet data output from the CPU 10 has reached (S310). If the packet data output from the CPU 10 has not reached (S310; No), the packet receiving unit 320-1 waits for arrival of the packet data output from the CPU 10. On the other hand, if the packet data output from the CPU 10 has reached (S310; Yes), the packet receiving unit 320-1 outputs the packet data to the packet collecting unit 330.

In addition, the packet receiving unit 320-2 determines whether packet data output from the CPU 20 has reached (S310). If the packet data output from the CPU 20 has not reached (S310; No), the packet receiving unit 320-2 waits for arrival of the packet data output from the CPU 20. On the other hand, if the packet data output from the CPU 20 has reached (S310; Yes), the packet receiving unit 320-2 outputs the packet data to the packet collecting unit 330.

Further, the packet receiving unit 320-3 determines whether packet data output from the CPU 60 has reached (S310). If the packet data output from the CPU 60 has not reached (S310; No), the packet receiving unit 320-3 waits for arrival of the packet data output from the CPU 60. On the other hand, if the packet data output from the CPU 60 has reached (S310; Yes), the packet receiving unit 320-3 outputs the packet data to the packet collecting unit 330.

Subsequently, after having received the packet data from the packet receiving unit 320-1, for example, the packet collecting unit 330 determines whether any CPU is multiplexed with the CPU 10 that output the packet data received with the packet receiving unit 320-1 (S320). If no CPU is multiplexed with the CPU 10 (S320; No), the packet collecting unit 330 outputs the packet data to the path selecting unit 360.

On the other hand, if any CPU is multiplexed with the CPU 10 (S320; Yes), the packet collecting unit 330 determines whether packet data output from the synchronized CPU has reached (S330). If the packet data output from the synchronized CPU has not reached (S330; No), the packet collecting unit 330 waits for arrival of packet data output from the synchronized CPU. On the other hand, if the packet data output from the synchronized CPU has reached (S330; Yes), the packet collecting unit 330 outputs plural packet data sent from the synchronized CPUs to the packet comparison unit 340.

After receiving the two packet data, the packet comparison unit 340 compares LCRCs added to the packet data (S140).

At this time, the packet comparison unit 340 determines whether all LCRCs added to plural packet data match each other (S350). If all LCRCs do not match each other (S350; No), the packet comparison unit 340 determines whether some of the LCRCs match each other (S370).

If it is determined that some of the LCRCs match each other (S370; Yes), the packet comparison unit 340 outputs packet information including a set of packet data corresponding to the matched LCRCs and the number of matched LCRCs toward the majority decision unit 510.

After receiving the packet information, the majority decision unit 510 compares the numbers of matched LCRCs in the set, out of sets in the packet information to determine a set of LCRCs by majority (S380). After that, the majority decision unit 510 outputs plural packet data corresponding to the determined number of LCRCs toward the packet selecting unit 350.

On the other hand, if none of the LCRCs match each other (S370; No), the packet comparison unit 340 outputs a message that an error occurs during the synchronous operation (S390) and terminates the synchronous operation.

If all LCRCs match each other (S350; Yes), the packet comparison unit 340 outputs packet data corresponding to the matched LCRCs to the packet selecting unit 350.

After receiving plural packet data from the packet comparison unit 340 or the majority decision unit 510, the packet selecting unit 350 selects one of the plural packet data (S360), and deletes the other packet data. After that, the packet selecting unit 350 outputs the selected packet data to the path selecting unit 360.

After receiving the packet data from the packet collecting unit 330 or the packet selecting unit 350, the path selecting unit 360 selects an identification number of a port for outputting the packet data, based on a destination included in the packet data, for example (S400). Then, the path selecting unit 360 outputs the packet data and the selected port identification number to the 370.

After receiving the packet data and the port identification number, the 370 duplicates the packet data as many times as the number of multiplexed input/output devices as a destination of the packet data (S410). For example, the 370 reads a set corresponding to the port identification number from the port number correspondence table and including a port identification number of each of multiplexed input/output devices. Then, the 370 duplicates the packet data as many times as the number of ports included in the read set. Further, the 370 outputs the duplicated packet data to the pseudo port determination units 381-1 to 381-6 corresponding to the port identification numbers included in the read set.

Then, after receiving the packet data output from the 370, the pseudo port determination units 381-1 to 381-6 determine whether the port in each unit is a pseudo port (S420). If the port in each unit is a pseudo port (S420; Yes), the pseudo port determination units 381-1 to 381-6 delete the packet data (S430). On the other hand, if the port in each unit is not a pseudo port (S420; No), the pseudo port determination units 381-1 to 381-6 send packet data to each input/output device connected to the ports, for example, the input/output devices 40-1, 50-1, and 60-1 (S440).

According to the second embodiment, the PCI Express switch 70 obtains an LCRC used for detecting an error in packet data representing a result of processing in the CPU 10 connected to its own device as above. If the PCI Express switch 70 receives the LCRC of the packet data representing a result of processing in the CPU 10, it is determined whether one or more devices are multiplexed with the CPU 10 and operated in sync with the CPU 10 to execute the same processing at the same time. If any synchronized device is found, the PCI Express switch 70 obtains an LCRC of packet data representing a result of the synchronous operation of the synchronized devices. Then, the PCI Express switch 70 compares the obtained LCRCs of the packet data output from the CPU 10 and the devices operating in sync with the CPU 10. Further, if some of three or more LCRCs match each other, the numbers of packet data are compared to select packet data corresponding to LCRCs selected by majority. Then, the PCI Express switch 70 duplicates the selected packet data as many times as the number of devices synchronous with the device as a destination of the packet data.

As described above, even if an error is involved in one of plural packet data representing a result of synchronous processing, the packet data involving the error can be complemented to packet data corresponding to LCRCs selected by majority as a result of comparing the numbers of LCRCs and thus, the synchronous processing can be continuously performed with reliability. As a result, a high-reliability system can be configured.

All or some of the processing functions of the PCI Express switch 30 or 70 can be realized by a program analyzed and executed on a CPU or realized in the hardware form based on wired logic.

The following appendixes are additionally attached as embodiment modes for the above embodiments.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A transfer device comprising:
a first input port operatively connected to a first apparatus;
a second input port operatively connected to a second apparatus which is to run in parallel to the first apparatus;
an output port operatively connected to a third apparatus; and
a controller for controlling a data synchronization in accordance with a process including:
receiving first and second data packets in parallel from the first and second apparatus via the first and second inputs port, respectively, each of the first and second data packets including a check code generated by check code operation over data contained in each of the first and second data packets,
comparing one of the check codes in the first and second data packet with the other, and
transferring at least the data of one of the first and second data packets upon determining coincidence of the check codes of the first and second data packets to the third apparatus via the output port.

2. The transfer device according to claim 1, wherein the controller determines whether a fourth apparatus is connected to the transfer device or not upon determining coincidence of the check codes of the first and second data packets, the fourth apparatus receiving the packet data from the transfer device, and discards the data of one of the first and second data packets when fourth apparatus is not connected to the transfer device.

3. The transfer device according to claim 1, wherein the controller compares more than three check codes including the check codes in the first and second data, and selects data packets corresponding to check codes by a majority decision.

4. The transfer device according to claim 3, wherein the controller duplicates the data packet as many times as the number of apparatuses which processes in synchronization with the packet receiving device.

5. The transfer device according to claim 4, wherein the controller selects a path through which the data packet is outputted on the basis of states of third and fourth apparatus.

6. The transfer device according to claim 5, wherein the controller selects paths which operates in synchronization with the selected path on the basis of path information indicative of a pair of predetermined paths which operate in synchronization with each other.

7. The transfer device according to claim 6, further comprising:
a plurality of output ports for transferring a plurality of data packets which are duplicated by the controller, to the plurality of paths which are selected by the controller.
